(19) United States
(12) Patent Application Publication
(10) Pub. No.: US 2022/0300714 A1
(43) Pub. Date: Sep. 22, 2022

(54) INFORMATION PROCESSING APPARATUS, INFORMATION PROCESSING METHOD, AND INFORMATION PROCESSING PROGRAM

(71) Applicant: Sony Group Corporation, Tokyo (JP)

(72) Inventor: Junki OHMURA, Tokyo (JP)

(73) Assignee: Sony Group Corporation, Tokyo (JP)

(21) Appl. No.: 17/767,047

(22) PCT Filed: Oct. 21, 2020
(86) PCT No.: PCT/JP2020/039499

§ 371 Date: Apr. 7, 2022

(30) Foreign Application Priority Data
Nov. 7, 2019 (JP) 2019-202727

(51) Int. Cl. G06F 40/30; G06F 40/166; G06F 40/211

(52) U.S. Cl. CPC G06F 40/30; G06F 40/166; G06F 40/211

(57) ABSTRACT

A development support device (10) corresponding to an example of an information processing apparatus includes: an acquisition unit 15A that acquires original data; a masking unit 15B that performs mask processing on a part of the original data: and a restoration reception unit 15D that receives an input of restoring a masked portion of masked data obtained by the mask processing.

### FIELD

The present invention relates to an information processing apparatus, an information processing method, and an information processing program.

### BACKGROUND

System development sometimes includes collection of cases corresponding to domains of tasks defined in the system. For example, in an exemplary case of an interactive agent, pieces of utterance data are collected as cases in an assumption of various use cases in an aspect of mapping inputs of a natural language from the user to semantic symbols defined in a module of utterance semantic analysis. Such cases are created by, merely as an example, authorized persons including a developer belonging to a business operator as a system developer and operators which may include a cloud worker or the like performing operations outsourced from the system developer.

### CITATION LIST

### Patent Literature

Patent Literature 1: JP 2017-219845 A
Patent Literature 2: JP 2018-180936 A

### Non Patent Literature

Non Patent Literature 1: Jacob Devlin, Ming-Wei Chang, Kenton Lee, Kristina Toutanova “BERT: Pre-training of Deep Bidirectional Transformers for Language Understanding”

### SUMMARY

### Technical Problem

However, there are limitations and biases in ideas conceivable to the above operators, making it difficult to acquire cases with sufficiently wide variations.

In view of this, the present disclosure proposes an information processing apparatus, an information processing method, and an information processing program capable of acquiring cases with sufficiently wide variations.

### Solution to Problem

In order to solve the above problem, an information processing apparatus according to an aspect of the present disclosure includes: an acquisition unit that acquires original data; a masking unit that performs mask processing on a part of the original data; and a restoration reception unit that receives an input of restoring a masked portion of masked data obtained by the mask processing.

### BRIEF DESCRIPTION OF DRAWINGS

FIG. 1 is a diagram illustrating a configuration example of a system according to an embodiment of the present disclosure.

FIG. 2A is a diagram illustrating an example of original data.

FIG. 2B is a diagram illustrating an example of masked data.

FIG. 2C is a diagram illustrating an example of restored data.

FIG. 3 is a flowchart illustrating a procedure of mask processing.

FIG. 4 is a flowchart illustrating a procedure of restoration reception processing.

FIG. 5 is a flowchart illustrating a procedure of registration processing.

FIG. 6 is a diagram illustrating an example of creation of an utterance case of a relay style.

FIG. 7 is a diagram illustrating an example of a visualization map.

FIG. 8 is a diagram illustrating an example of a confusion matrix.

FIG. 9 is a diagram illustrating an example of a cluster.

FIG. 10 is a diagram illustrating a modification of a case.

FIG. 11 is a diagram illustrating an example of a method of augmentation of a case in an interactive task.

FIG. 12 is a diagram illustrating an example of a method of augmentation of a case in an image classification task.

FIG. 13 is a diagram illustrating an example of a method of augmentation of a case in a motion classification task.

FIG. 14 is a diagram illustrating an example of a method of augmentation of a case in a path search task.

FIG. 15 is a hardware configuration diagram illustrating an example of a computer 1000 that implements functions of a development support device 100.

### DESCRIPTION OF EMBODIMENTS

Embodiments of the present disclosure will be described below in detail with reference to the drawings. Note that, in each of the following embodiments, the same parts are denoted by the same reference symbols, and a repetitive description thereof will be omitted.

The present disclosure will be described in the following order.

1. Definition of terms

1-1. Interaction

1-2. Utterance semantic analysis

1-3. Interactive system

1-4. Interactive Agent

2. System configuration example

2-1. Overall configuration

2-2. Development support device

2-3. Operator terminal

2-4. Operation requester terminal

3. Overview of masked data augmentation

4. Functional configuration example of development support device

4-1. Communication interface

4-2. Storage unit

4-2-1. Task data

4-2-1-1. Original data

4-2-2. Restored data

4-2-3. Corpus data

4-3. Control unit

4-3-1. Acquisition unit

4-3-2. Masking unit

4-3-3. Allocation unit

4-3-4. Restoration reception unit

4-3-5. Progress management unit

4-3-6. Registration unit

5. Processing procedure of development support device

5-1. Mask processing

5-2. Restoration reception processing

5-3. Registration processing

6. One aspect of effect

7. Application example

7-1. Partial sharing of utterance cases

7-2. Creating relay style utterance case

7-3. Providing context

7-4. Support for efficient data collection for training model

7-4-1. Visualization of utterance cases

7-4-2. One aspect of visualization effect

7-5. Linkage with evaluation

7-6. Support for collection of utterance cases connecting isolated regions

8. Modifications

8-1. Modification of cases

8-1-1. Interactive task

8-1-2. Image classification task

8-1-3. Motion classification task

8-1-4. Path search task

8-2. Other modifications

9. Hardware configuration

<<1. Definition of Terms>>

Definitions of terms used in the present embodiment will be described.

<1-1. Interaction>

“Interaction” refers to an action of exchanging information such as utterances between persons or even machines. Here, interaction is not limited to execution of an exchange once, and can include an occasion of performing a plurality of times of exchanges. In a case where the exchange is performed a plurality of times, it is necessary to select the exchange in consideration of previous exchanges. In addition, there are forms of interaction such as one-to-one, one-to-many, and many-to-many.

<1-2. Utterance Semantic Analysis>

“Utterance semantic analysis” refers to a module that maps a user's input of a natural language using text or voice to semantic symbols predefined on the system side. For example, when a text “show me what's the weather will be like tomorrow” is input, the text is mapped to a semantic symbol represented by a sign such as WEATHER-CHECK (tomorrow). In addition, the semantic symbol is referred to as an “interactive action” in the interactive system, and a portion corresponding to an argument is referred to as “slot” in some cases. By representing various utterance expressions (utterance variations) by specific symbols, it is possible to enhance machine handleability, leading to achievement of bridging individual differences in various user expressions.

<1-3. Interactive System>

An “interactive system” refers to a system capable of exchanging some information (interacting) with the user. For example, although the exchange uses a natural language using text, utterance, or the like, an exchange is not limited to this method, and may use a gesture, an eye contact, and the like. In the interactive system, the utterance semantic analysis module described above may be incorporated as one module.

<1-4. Interactive Agent>

The “interactive agent” refers to a service developed by being equipped with an interactive system. For example, an interactive agent may actually have a display device or a body, or may be provided as a graphical user interface (GUI) like an application of a smartphone.

<<2. System Configuration Example>>

<2-1. Overall Configuration>

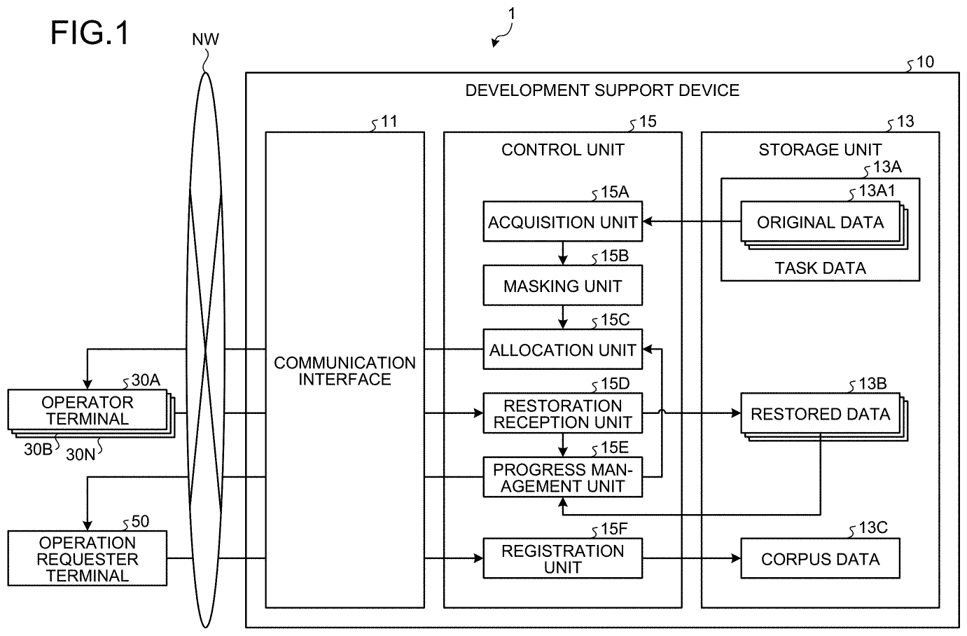

FIG. 1 is a diagram illustrating a configuration example of a system 1 according to an embodiment of the present disclosure. The system 1 illustrated in FIG. 1 provides a development support service that supports system development. As part of such a development support service, the system 1 also provides a workspace providing service that provides a workspace in which work of creating the above cases is performed.

Although the following will be merely an example of collecting utterance cases in system development, namely development of an interactive system, an interactive agent, and the like as an example of the cases, objects of collection are not limited to this example. Although details will be described below, it should be noted beforehand that cases other than utterances may be collected.

As illustrated in FIG. 1, the system 1 can include a development support device 10, operator terminals 30A to 30N, and an operation requester terminal 50. Hereinafter, when there is no need to distinguish between each of the operator terminals 30A to 30N, the terminal may be described as an “operator terminal 30”. Although FIG. 1 illustrates an example in which one operation requester terminal 50 is included in the system 1, a plurality of operation requester terminals 50 may be included.

The development support device 10, the operator terminal 30, and the operation requester terminal 50 can be connected to each other via an arbitrary network NW. For example, the network NW may be any type of communication network such as the Internet or a local area network (LAN) regardless of whether it is wired or wireless connection.

<2-2. Development Support Device>

The development support device 10 is a computer that provides the above-described development support service. The development support device 10 can correspond to an example of an information processing apparatus.

As one embodiment, the development support device 10 can be implemented by installing a development support program actualizing the above development support service in a desired computer as package software or online software. For example, the development support device 10 can be implemented as a server, for example, a Web server, that provides the above-described functions related to the development support service on-premises. The implementation of the service is not limited thereto, and the development support device 10 may provide the above development support service as a cloud service by having Software as a Service (SaaS) application.

<2-3. Operator Terminal>

The operator terminal 30 is a computer used by the above operator. Here, the label “operator terminal” is merely a classification in one aspect of the user, and the type of computer and the hardware configuration thereof are not limited to specific ones, and may be any type of computer. For example, the operator terminal 30 can be a desktop or laptop personal computer and the like. This is merely an example, and the operator terminal 30 may be any other computer such as a portable terminal device or a wearable terminal.

<2-4. Operation Requester Terminal>

The operation requester terminal 50 is a computer used by an operation requester. The term “operation requester” as used herein refers to a person who performs development or design with the intention of generating a corpus of utterance cases, and can include, for example, an individual developer belonging to a business operator as a developer company of an interactive system or an interactive agent, and an affiliation member of the business operator. In addition, the label “operation requester terminal” is merely a classification in one aspect of the user, and the type of computer and the hardware configuration thereof are not limited to specific ones, and may be any type of computer similarly to the above operator terminal 30.

<<3. Overview of Masked Data Augmentation>>

As described in the section of Background above, there is a limitation or bias in the ideas conceivable to the operators, making it difficult to acquire cases with sufficiently wide variations.

To handle this problem, the development support device 10 of the present disclosure performs “masked data augmentation” that receives information restoration with respect to an information loss in masked data obtained by masking a part of original data. Such an approach for solving the problem can be adopted only based on the technical knowledge that the information loss and the error generated in the process of the information restoration are applicable to the augmentation of the original data.

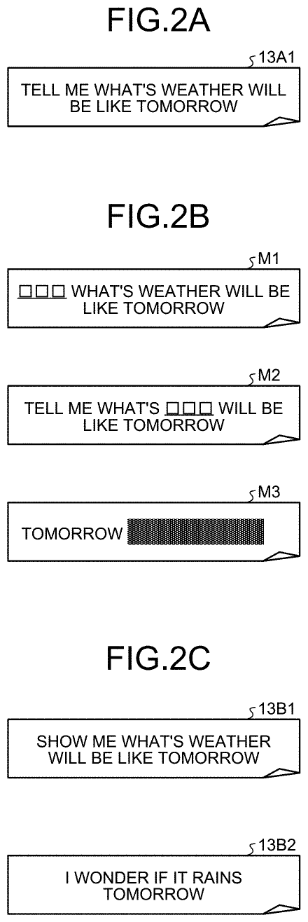

FIG. 2A is a diagram illustrating an example of original data. FIG. 2A exemplifies a case where utterance cases corresponding to the domain of the semantic symbol “WEATHER-CHECK (tomorrow)” are collected as an example only. As illustrated in FIG. 2A, original data 13A1 includes an utterance text “Tell me what's the weather will be like tomorrow”. Such original data 13A1 can be provided by using an utterance text that has been created by the above operation requester or operator, merely as an example.

FIG. 2B is a diagram illustrating an example of masked data. FIG. 2B illustrates pieces of masked data M1 to M3 generated from the utterance text “Tell me what's the weather will be like tomorrow” in the original data 13A1. For example, by masking the word “tell me” in the utterance text of the original data 13A1, it is possible to obtain, as illustrated in FIG. 2B, masked data M1 including an utterance text “□□□ what's the weather will be like tomorrow” in which the portion of the word “tell me” is hidden with a mask “□□□”. Furthermore, by masking the word “weather” in the utterance text of the original data 13A1, it is possible to obtain, as illustrated in FIG. 2B, masked data M2 including an utterance text “Tell me what's the □□□ will be like tomorrow” in which a portion of the word “weather” is hidden with the mask “□□□”. Furthermore, by masking the phrase “tell me what's the weather will be like” in the utterance text of the original data 13A1, it is possible to obtain, as illustrated in FIG. 2B, masked data M3 including an utterance text “tomorrow (with other portions hidden with black-out)” in which a portion of the phrase “tell me what's the weather will be like” is masked by black-out.

For example, the masked data M1 to M3 can be displayed on the operator terminal 30. When the masked data M1 to M3 are displayed on the operator terminal 30, the operator performs an input to restore the masked portions of the masked data M1 to M3. At this time, the operator estimates and inputs a word or phrase corresponding to the masked portion from the context of the non-masked portion and the masked portion in the masked data M1 to M3. In this manner, the development support device 10 receives restoration of the masked portions of the masked data M1 to M3 from the operator terminal 30. This makes it possible to obtain restored data in which information in the masked portions of the masked data M1 to M3 is restored.

FIG. 2C is a diagram illustrating an example of restored data. FIG. 2C illustrates restored data 13B1 restored from the masked data M1 and restored data 13B2 restored from the masked data M3. As illustrated in FIG. 2C, the utterance text “show me what's the weather will be like tomorrow” in the restored data 13B1 does not match the utterance text “tell me what's the weather will be like tomorrow” in the original data 13A1. This makes it possible to acquire, as a new utterance case, the restored data 13B1 which uses the words “show me” that belongs to the domain of the semantic symbol “WEATHER-CHECK (tomorrow)” and that is a different way of asking from the words “tell me” in the original data 13A1. Furthermore, the utterance text “I wonder if it rains tomorrow” of the restored data 13B2 does not match the utterance text “Tell me what's the weather will be like tomorrow” in the original data 13A1. This makes it possible to acquire, as a new utterance case, the restored data 13B2 which uses the phrase “I wonder if it rains” that belongs to the domain of the semantic symbol “WEATHER-CHECK (tomorrow)” and that is a different way of asking from the phrase “tell me what's the weather will be” in the original data 13A1.

In this manner, the information loss and the error occurring in the process of the information restoration makes it possible to acquire an utterance case having a different word or phrase without changing the uttered meaning of the utterance text of the original data 13A1 while using the utterance text of the original data 13A1 as a base. Furthermore, when the utterance text of the original data 13A1 includes words and phrases inconceivable to the operator, and includes a sequence of these words and phrases, it is possible to acquire an utterance case beyond the range conceivable to the operator from the semantic symbol “WEATHER-CHECK (tomorrow)” alone.

Therefore, according to the development support device 10 of the present disclosure, it is possible to acquire cases with sufficiently wide variations.

<<4. Functional Configuration Example of Development Support Device>>

Next, a functional configuration example of the development support device 10 of the present disclosure will be described. In FIG. 1, functions of the development support device 10 among devices included in system 1 are schematically illustrated as blocks. As illustrated in FIG. 1, the development support device 10 includes a communication interface 11, a storage unit 13, and a control unit 15.

Note that FIG. 1 merely illustrates excerpted functional units related to the above-described workspace providing service, and shall not preclude the development support device 10 from including functional units other than those illustrated, being functional units equipped by default or optionally on an existing computer, for example. For example, functional units related to the above development support service may be provided in addition to the functional units related to the above workspace providing service.

<4-1. Communication Interface>

The communication interface 11 is an interface that performs communication control with other devices, for example, the operator terminal 30 or the operation requester terminal 50.

Merely as an example, the communication interface 11 can be implemented by adopting a network interface card such as a LAN card. For example, the communication interface 11 receives setting of a task performed on the workspace from the operation requester terminal 50, and receives a confirmation operation of registering the utterance text being the restored data as an utterance case. In addition, the communication interface 11 distributes the masked data allocated to the operator terminals 30A to 30N to the operator terminals 30A to 30N, and receives restored data in which masked portions of the masked data have been restored.

<4-2. Storage Unit>

The storage unit 13 corresponds to a piece of hardware that stores data used for various programs such as an operating system (OS) executed by the control unit 15 and a workspace providing program corresponding to the above-described workspace providing service.

As one embodiment, the storage unit 13 may correspond to an auxiliary storage device in the development support device 10. For example, a hard disk drive (HDD), an optical disk, a solid state drive (SSD), or the like corresponds to the auxiliary storage device. In addition, a flash drive such as erasable programmable read only memory (EPROM) can also correspond to the auxiliary storage device.

The storage unit 13 stores task data 13A, restored data 13B, and corpus data 13C as an example of data used for the program executed by the control unit 15. The storage unit 13 can store various types of data in addition to the task data 13A, the restored data 13B, and the corpus data 13C. For example, in addition to the account information of the operator and the operation requester, the storage unit 13 can store a development support program corresponding to the development support service described above, data used by the development support program, and the like.

<4-2-1. Task Data>

The task data 13A is data related to a task performed on the above-described workspace. The term “task” as used herein refers to a job that the operation requester assigns to the operator. For example, the task data 13A may be data in which the original data 13A1, the number of utterance cases requesting collection in the domain of the semantic symbol, and the like are associated with each task, for example, each utterance semantic analysis.

<4-2-1-1. Original Data>

The original data 13A1 is source data that is an original of an augmentation source.

Merely as an example, it is possible to use, as the original data 13A1, an utterance text created via the operator terminal 30 or the operation requester terminal 50 before execution of the “masked data augmentation” described above. Furthermore, it is also possible to use an utterance text recorded in a log of an interactive system or an interactive agent as the original data 13A1. Furthermore, it is also possible to use, as the original data 13A1, a predetermined number of higher order results among N-best results obtained by performing voice synthesis on the utterance text of the original data 13A1 and performing voice recognition on the synthesized voice obtained by the voice synthesis. Other examples of the original data 13A1 can include a result of retranslation of the utterance text of the original data 13A1 once translated into a certain language different from the language of the utterance text back into the original language. Furthermore, another example of the original data 13A1 can be data obtained by inputting an utterance text of the original data 13A1 to a paraphrase (sentences of the same meaning in different expression) language generation model pre-trained by a neural network or the like and by taking an output from the language generation model.

<4-2-2. Restored Data>

The restored data 13B is data in which masked portions of the masked data have been restored.

Merely as an example, when an input of restoring the masked portion of the masked data from the operator terminal 30 has been received by a restoration reception unit 15D described below, the restored data 13B is generated as follows. Specifically, restored data is generated by combining the text of which restoration input has been received by the restoration reception unit 15D described below and the text other than the masked portion. Furthermore, it is also allowable to have a configuration at the time of reception of the input of the restoration in which not only the masked portion but also characters or character strings other than the masked portion are further received.

<4-2-3. Corpus Data>

The corpus data 13C is data being a corpus formed of collection of utterance cases corresponding to the utterance text of the restored data 13B.

Merely as an example, when a predetermined condition regarding variations is satisfied, for example, when the number of utterance texts of the restored data 13B stored in the storage unit 13 reaches a predetermined number, a list of utterance texts of the restored data 13B will be displayed for confirmation on the operation requester terminal 50. When the registration operation of registering the utterance text of the restored data 13B as the utterance case has been received via the operation requester terminal 50 on which such confirmation display has been performed, the utterance case and its accompanying meta information, for example, a ground truth label of the semantic symbol, will be additionally registered by a registration unit 15F described below. Note that it is also allowable to edit a certain utterance text of the restored data 13B in the list of the utterance texts of the restored data 13B at the time of the registration operation described above.

<4-3. Control Unit>

The control unit 15 is a processing unit that performs overall control of the development support device 10.

As one embodiment, the control unit 15 can be implemented by a hardware processor such as a central processing unit (CPU) or a micro processing unit (MPU). Here, although the CPU and the MPU have been presented as an example of the processor, the processor can be implemented by any type of processor regardless of the general-purpose type and the application-specific type. In addition, the control unit 15 may be implemented by hard-wired logic such as an application specific integrated circuit (ASIC) or a field programmable gate array (FPGA).

The control unit 15 performs virtual implementation of the following processing units by developing the above-described workspace providing program on a work area of random access memory (RAM) mounted as a main storage device (not illustrated). Note that, although FIG. 1 illustrates functional units corresponding to the above-described workspace providing program, it is also allowable to include functional units corresponding to packaged software in which the above-described workspace providing program is packaged in the above-described development support program.

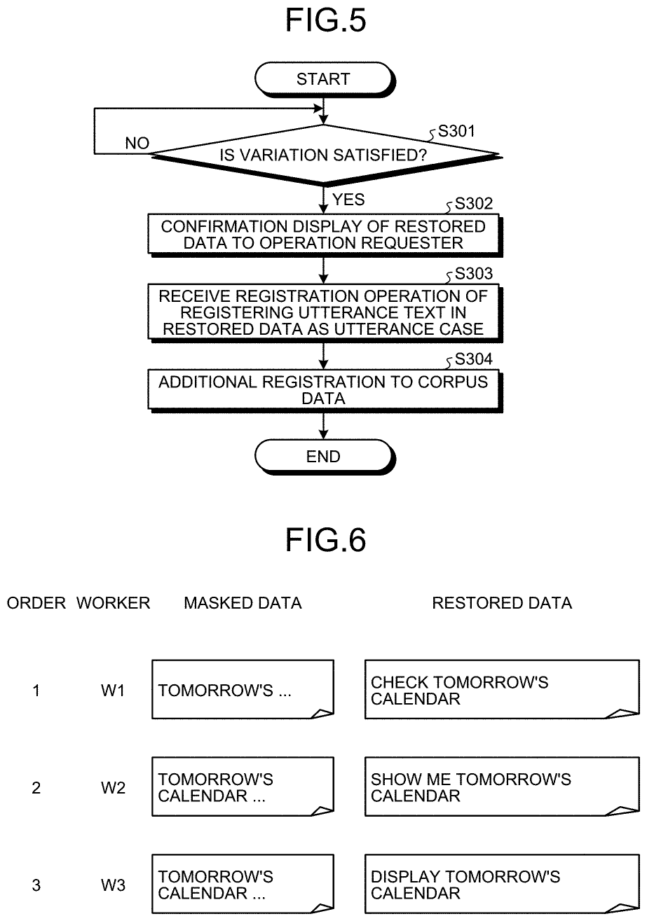

As illustrated in FIG. 5, the control unit 15 includes an acquisition unit 15A, a masking unit 15B, an allocation unit 15C, a restoration reception unit 15D, a progress management unit 15E, and a registration unit 15F.

<4-3-1. Acquisition Unit>

The acquisition unit 15A is a processing unit that acquires the original data 13A1.

Merely as an example, the acquisition unit 15A acquires the original data 13A1 from the storage unit 13 at timings including when the task data 13A is stored in the storage unit 13, when a task execution request is made from the operation requester terminal 50, or when the time reaches a predetermined periodic time. At this time, from among the original data 13A1 stored in the storage unit 13, the acquisition unit 15A can extract original data satisfying the following conditions. For example, the acquisition unit 15A can extract the original data 13A1 in which a content word having a low occurrence frequency among the original data 13A1 stored in the storage unit 13 is included in the utterance text. Furthermore, the acquisition unit 15A can also extract original data 13A1 including an utterance text of a grammatical series having a low occurrence frequency among the original data 13A1 stored in the storage unit 13, for example, an utterance text “set ΔΔ of ◯◯” or the like. Furthermore, the acquisition unit 15A can also extract original data 13A1 including utterance text having a sentence length, for example, the number of characters of a character string constituting a sentence, with low occurrence frequency, from among the original data 13A1 stored in the storage unit 13.

Note that the term “low occurrence frequency” as used herein refers a situation in which the frequency is a predetermined threshold or less, or the frequency rank is a predetermined number which belongs to a low rank. In addition, the acquisition unit 15A may use the above-described extraction condition under an AND condition or an OR condition.

<4-3-2. Masking Unit>

The masking unit 15B is a processing unit that masks a part of the utterance text in the original data.

Merely as an example, the masking unit 15B masks a part of an utterance text in the original data acquired by the acquisition unit 15A, in units of the utterance text. The “masking” referred to herein can use the following methods. For example, the masking unit 15B can mask a predetermined word class, a predetermined number of content words, or a predetermined portion indicating a syntactic dependency relationship in the utterance text in the original data. Furthermore, the masking unit 15B can mask a character string corresponding to a predetermined number of characters in the utterance text in the original data. Furthermore, the masking unit 15B can randomly mask a predetermined number of characters in the utterance text in the original data. Furthermore, the masking unit 15B can mask a prefix, which is an affix placed before a word, or a suffix, which is an affix placed after a word, in the utterance text in the original data. The masking methods listed here may be used under an AND condition or an OR condition.

Note that the masking unit 15B does not necessarily have to completely hide the masked portion. For example, the masking unit 15B may lower the visibility by blurring characters corresponding to the masked portion, setting a limit on the display time of the masked portion, or performing scroll display of the utterance text in the original data at a predetermined speed.

<4-3-3. Allocation Unit>

The allocation unit 15C is a processing unit that allocates masked data.

Merely as an example, the allocation unit 15C can proportionally allocate the masked data generated by the masking unit 15B according to the number of operators corresponding to the operator terminals 30A to 30N. In addition, when the skill data in which the skill of the operator is indexed is referable, the allocation unit 15C can change the number of pieces of master data to be allocated to the operator terminals 30A to 30N according to the score or level of the skill of the operator. For example, the allocation unit 15C allocates mask data such that the higher the score or level of the skill of the operator, the more masked data will be allocated, and the lower the score or level of the skill of the operator, the less masked data will be allocated. It is allowable either to permit allocation of same masked data redundantly to a plurality of operator terminals 30 or prohibit allocation of the same masked data to a plurality of operator terminals 30.

After determination of allocation of masked data to the operator terminal 30 in this manner, the allocation unit 15C starts distribution of the masked data allocated to the operator terminal 30. For example, the allocation unit 15C sequentially distributes the masked data allocated to the operator terminal 30 according to an instruction of the progress management unit 15E described below. Although here is merely an example in which the masked data is distributed sequentially for illustrative purpose, it is also allowable to simultaneously distribute all the masked data allocated to the operator terminal 30.

<4-3-4. Restoration Reception Unit>

The restoration reception unit 15D is a processing unit that receives restoration of a masked portion of masked data.

Merely as an example, when the masked data distributed by the allocation unit 15C is displayed on the operator terminal 30, the restoration reception unit 15D receives restoration of the masked portion of the masked data from the operator terminal 30. At this time, the operator does not necessarily have a skill to restore the masked portions of all the masked data. This is because the entire operators include not only operators skilled in augmenting variations but also operators not skilled in augmenting variations. Therefore, in the aspect of suppressing the influence of stopping progress in a part of operation on the progress of other operations, the restoration reception unit 15D can also receive the input of prohibiting restoration from the operator terminal 30.

Here, the restoration reception unit 15D does not immediately generate the restored data just because restoration of the masked portion of the masked data has been received from the operator terminal 30. That is, the restoration reception unit 15D generates restored data only when the restored text satisfies a predetermined constraining condition.

For example, when the number of characters of the restored text is different from the number of characters of the text of the masked portion, the restoration reception unit 15D permits generation of the restored data. This would prohibit generation of the restored data when the number of characters is the same, making it is possible to increase the possibility of acquiring an utterance case different from the utterance text in the original data. In addition, it is also allowable to configure such that the restoration reception unit 15D permits generation of restored data when a predetermined prohibited character is not included in the restored text. For example, when the masked portion of the masked data M2 illustrated in FIG. 2B is restored, the use of the word “tell me” included in the text of the masked portion is prohibited. This can increase the possibility to restore the word representing a way of asking different from the word “tell me”. Furthermore, it is also possible to configure such that the restoration reception unit 15D permits generation of restored data when an edit distance between the restored text and the text of the masked portion is equal to more than a threshold. This would prohibit use of the words and phrases same as the masked portion, making it is possible to increase the possibility of acquiring an utterance case different from the utterance text in the original data. For example, it is also possible to configure such that the restoration reception unit 15D permits generation of restored data when the form of the restored text is different from the form of the text of the masked portion. For example, when the masked portion is a colloquial language, the use of a written language is permitted while the use of a colloquial language is prohibited at the time of restoration. This makes it possible to expect a difference in modal (an impression felt by the listener toward the speaker when the utterance is heard), leading to a higher possibility of acquiring an utterance case different from the utterance text in the original data. In addition, it is also allowable to configure such that the restoration reception unit 15D permits generation of restored data when the restored text is a predetermined dialect. For example, when the masked portion is colloquial, use of a dialect different from the dialect of the masked portion is permitted, while use of the same dialect as the masked portion is prohibited at the time of restoration. This can also increase the possibility of acquiring an utterance case different from the utterance text in the original data. Note that the constraining conditions listed here may be used under an AND condition or an OR condition. Furthermore, the restoration reception unit 15D can also use error fluctuation of voice recognition in voice input. For example, the restored data can also be generated using a voice recognition result obtained by performing voice recognition on the voice based on the restored text by either the operator terminal 30 or the restoration reception unit 15D.

In a case where the text restored in this manner satisfies a predetermined constraining condition, the restoration reception unit 15D generates restored data by combining the text input of which has been received for restoration with the text other than the masked portion. Note that it is also allowable to configure to receive, at the time of restoration, edition of not only the masked portion but also characters or character strings other than the masked portion. Furthermore, when the utterance text of the newly generated restored data overlaps with the utterance text of the restored data stored in the storage unit 13, it is possible to enable only one registration. At this time, in the aspect of managing the number of created utterance cases for each operator, the operator of the restored data may register both utterance texts.

<4-3-5. Progress Management Unit>

The progress management unit 15E is a processing unit that manages the progress of a task.

In one aspect, the progress management unit 15E monitors the progress of the information restoration for each of the operator terminals 30 after the distribution of the masked data is started by the allocation unit 15C. Specifically, the progress management unit 15E determines whether or not restoration of the masked portion has been received from the operator terminal 30. At this time, when the restored data of the masked portion has not been received, the progress management unit 15E further determines whether or not an input of prohibiting restoration has been received from the operator terminal 30. At this time, when the input of prohibiting restoration has been received from the operator terminal 30, the progress management unit 15E instructs the allocation unit 15C to allocate the masked data under restoration to another operator terminal 30. Furthermore, the progress management unit 15E instructs the allocation unit 15C to distribute the next masked data to the operator terminal 30 that has received the input of prohibiting restoration. In contrast, in a case where the input of prohibiting restoration has not been received from the operator terminal 30, the progress management unit 15E determines whether or not a predetermined time, for example, 1 minute or 5 minutes has elapsed since the distribution of the masked data to the operator terminal 30. When the predetermined time has elapsed, the progress management unit 15E instructs the allocation unit 15C to allocate the masked data under restoration to another operator terminal 30, and instructs the allocation unit 15C to distribute the next masked data to the operator terminal 30 that has received the input of prohibiting restoration.

In another aspect, the progress management unit 15E monitors the end condition of the task after the distribution of the masked data is started by the allocation unit 15C. Merely as an example, when the variation satisfies a predetermined condition, for example, when the number of utterance texts of the restored data 13B stored in the storage unit 13 has reached a predetermined number, the progress management unit 15E determines the end of the task. In this situation, the progress management unit 15E controls the operation requester terminal 50 to perform confirmation display of a list of utterance texts of the restored data 13B stored in the storage unit 13.

<4-3-6. Registration Unit>

The registration unit 15F is a processing unit that registers utterance cases in the storage unit 13.

Merely as an example, when having received a registration operation of registering the utterance text of the restored data 13B as the utterance case via the operation requester terminal 50, the registration unit 15F additionally registers the utterance case and meta information accompanying the utterance case in the corpus data 13C of the storage unit 13. Note that it is also allowable to edit a certain utterance text of the restored data 13B in the list of the utterance texts of the restored data 13B at the time of the registration operation described above.

<<5. Processing Procedure of Development Support Device>>

<5-1. Mask Processing>

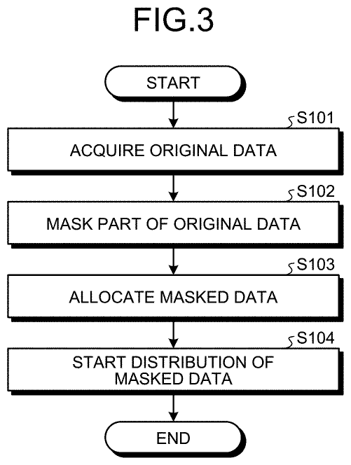

FIG. 3 is a flowchart illustrating a procedure of mask processing. Merely as an example, this processing is performed when the task data 13A is stored in the storage unit 13, when a task execution request is made from the operation requester terminal 50, or when the time reaches a predetermined periodic time.

As illustrated in FIG. 3, the acquisition unit 15A acquires original data 13A1 from the storage unit 13 (step S101). Subsequently, the masking unit 15B masks a part of an utterance text for each utterance text in the original data acquired in step S101 (step S102).

Thereafter, the allocation unit 15C allocates the masked data generated in step S102 to the operator terminal 30 (step S103). The allocation unit 15C then starts distribution of the masked data allocated to the operator terminal 30 in step S103 (step S104).

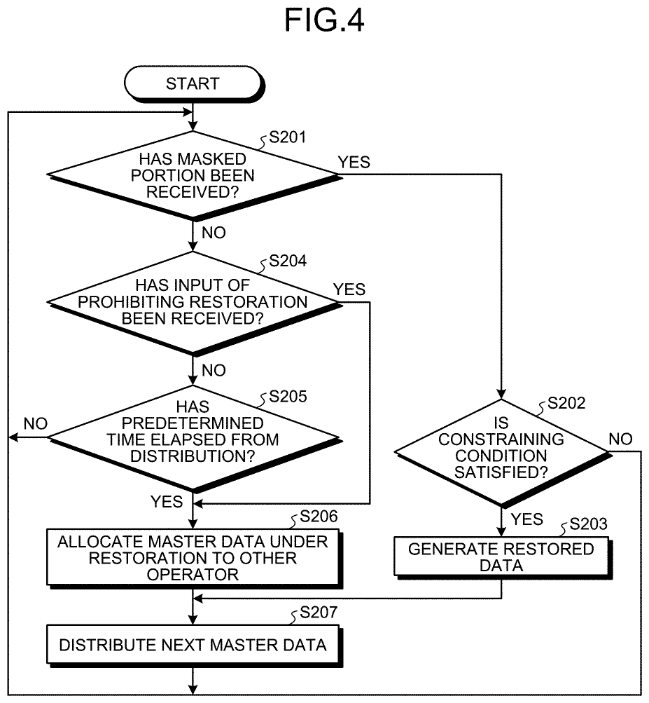

On condition that the distribution of the masked data to each operator terminal 30 is started in this manner, the restoration reception processing illustrated in FIG. 4 and the registration processing illustrated in FIG. 5 are executed in parallel.

<5-2. Restoration Reception Processing>

FIG. 4 is a flowchart illustrating a procedure of the restoration reception processing. Merely as an example, when the processing of step S104 illustrated in FIG. 3 has been executed, this processing is performed in parallel for each operator terminal 30.

As illustrated in FIG. 4, when the restoration of the masked portion of the masked data is received from the operator terminal 30 (step S201 Yes), the restoration reception unit 15D determines whether or not the restored text satisfies a predetermined constraining condition (step S202).

Here, when the restored text satisfies the predetermined constraining condition (step S202 Yes), the restoration reception unit 15D generates restored data by combining the text for which the restoration input has been received and the text other than the masked portion (step S203). Subsequently, the progress management unit 15E instructs the allocation unit 15C to distribute the next masked data to the operator terminal 30 (step S207), and the processing returns to step S201. When the restored text does not satisfy the predetermined constraining condition (step S202 No), the restored data will not be generated, and the processing returns to step S201.

In contrast, when the restored data of the masked portion has not been received from the operator terminal 30 (step S201 No), the progress management unit 15E further determines whether or not an input of prohibiting restoration has been received from the operator terminal 30 (step S204).

At this time, in a case where the input of prohibiting restoration has not been received from the operator terminal 30 (step S204 No), the progress management unit 15E determines whether or not a predetermined time, for example, 1 minute or 5 minutes has elapsed since the distribution of the masked data to the operator terminal 30 (step S205).

Here, when the predetermined time has elapsed (step S205 Yes), the progress management unit 15E instructs the allocation unit 15C to allocate the masked data under restoration to another operator terminal 30 (step S206). Furthermore, the progress management unit 15E instructs the allocation unit 15C to distribute the next masked data to the operator terminal 30 that has received the input of prohibiting restoration (step S207), and the processing proceeds to step S201. When the predetermined time has not elapsed (step S205 No), the processing returns to step S201.

When having received the input of prohibiting restoration from the operator terminal 30 (step S204 Yes), the progress management unit 15E instructs the allocation unit 15C to allocate the masked data under restoration to another operator terminal 30 (step S206). Furthermore, an instruction to the allocation unit 15C is made to distribute the next masked data to the operator terminal 30 that has received the input of prohibiting restoration (step S207), and the processing proceeds to step S201.

In this manner, for each operator terminal 30, the generation of restored data and the distribution of the next masked data, or re-allocation of the masked data under restoration, the skip distribution to the next masked data, and the like are repeatedly performed.

<5-3. Registration Processing>

FIG. 5 is a flowchart illustrating a procedure of registration processing. This processing is performed merely as an example when the processing of step S104 illustrated in FIG. 3 has been executed. As illustrated in FIG. 5, the progress management unit 15E determines whether or not the variation satisfies a predetermined condition, for example, whether or not the number of utterance texts of the restored data 13B stored in the storage unit 13 has reached a predetermined number (step S301).

At this time, when the predetermined condition regarding the variation is satisfied (step S301 Yes), the end of the task is determined. In this situation, the progress management unit 15E controls the operation requester terminal 50 to perform confirmation display of a list of utterance texts of the restored data 13B stored in the storage unit 13 (step S302).

Subsequently, the registration unit 15F receives a registration operation of registering the utterance text being the restored data 13B as an utterance case via the operation requester terminal 50 (step S303). Thereafter, the registration unit 15F additionally registers the utterance case and the meta information accompanying the utterance case in the corpus data 13C of the storage unit 13 (step S304) to end the processing illustrated in FIG. 5.

Note that it is also possible to end the processing illustrated in FIG. 4 when a predetermined condition regarding the variation is satisfied (step S301 Yes) or when the processing illustrated in FIG. 5 has ended.

<<6. One Aspect of Effect>>

As described above, according to an embodiment of the present disclosure, the development support device 10 performs “masked data augmentation” to receive information restoration on an information loss in masked data obtained by masking a part of the original data 13A1.

With these information loss and errors generated in the process of information restoration, it is possible to acquire an utterance case different from the word or phrase of the utterance text being the original data 13A1, based on the utterance text being the original data 13A1. Furthermore, when the utterance text being the original data 13A1 includes words and phrases inconceivable to the operator, and includes a sequence of these words and phrases, it is possible to acquire an utterance case beyond the range conceivable to the operator from a semantic symbol alone.

This makes it possible to acquire cases with sufficiently wide variations.

<<7. Application Example>>

The above-described embodiment is an example, and various applications are possible.

<7-1. Partial Sharing of Utterance Cases>

In a case where an operation is performed by a plurality of operators who create utterance cases related to semantic symbols of the same domain, there is a possibility of occurrence of bias in operations when each operator browses utterance cases of other operators.

In the aspect of suppressing such bias, the above embodiment has been described as an example in which an utterance case created by each operator is not disclosed to other operators. However, under a situation where the bias can be reduced, the utterance case may be disclosed to other operators. For example, when a predetermined time has elapsed from the start of the utterance case creation operation, or when the number of utterance cases created by all the operators or the operator having the lowest number of created cases has reached a predetermined number, the utterance text of the restored data can be disclosed to other operators.

At this time, there is no need to disclose entire utterance text of the restored data. For example, the above disclosure can be performed only for content words that are not included in the restored data of the operator of the disclosure destination. By disclosing a part or all of the utterance text of the restored data to other operators in this manner, it is possible to stimulate the imaginations of other operators.

Furthermore, due to a reason such as cost, there may be a situation in which one operator takes charge of creating an utterance case mapped to one semantic symbol. In such a situation, by generating a virtual worker having the ability to generate utterance text in the form of a user simulator, it is also possible to create a situation having a plurality of operators working in a pseudo manner. The user simulator refers to a program designed to take an action like a user, such as the present example of outputting characters or words of a masked portion in response to the input of masked data. The user simulator can be created through restored data that has been stored in the storage unit 13 so far, logs of the interactive system and interactive agent, a trained language model, and the like. While the cost increases in proportion to the amount of operation when using a human operator, the use of a virtual worker, which can be implemented on a computer, makes it possible to generate, with low cost, a large amount of utterance cases that cannot be achieved by a human operator after a user simulator is once generated.

<7-2. Creating Relay Style Utterance Case>

In the above-described embodiment, in the aspect of creating utterance cases with variations excluding biases of individual operators, it is also possible to generate utterance cases in a relay style by a plurality of operators. Merely as an example, by repeating processing of masking a word or phrase forward or backward in a certain utterance case and transferring the masked data to another operator, it is also possible to receive restoration of the masked portion from the other operator.

FIG. 6 is a diagram illustrating an example of creation of an utterance case of a relay style. FIG. 6 illustrates an example in which the relay is performed in the order of an operator W1, an operator W2, and an operator W3, merely as an example. As illustrated in FIG. 6, masked data “tomorrow's . . . ” generated from original data “confirm tomorrow's schedule” is displayed on the operator terminal 30 of the operator W1. Here, in the present example, as a result of receiving the restoration for the masked portion from the operator terminal 30 of the operator W1, restored data “check tomorrow's calendar” is generated. By masking the word “check” sequentially in a backward direction of the utterance text “check tomorrow's calendar” being the restored data obtained in this manner, masked data “ . . . tomorrow's calendar” is generated. Thereafter, the masked data “ . . . tomorrow's calendar” is distributed to the operator terminal 30 of the operator W2 and the operator terminal 30 of the operator W3. Here, in the present example, as a result of receiving the restoration on the masked portion from the operator terminal 30 of the operator W2, restored data “show me tomorrow's calendar” is generated. Furthermore, as a result of receiving restoration on the masked portion from the operator terminal 30 of the operator W3, restored data “display tomorrow's calendar” is generated. Such relays make it possible to acquire utterance cases with variations.

Although FIG. 6 illustrates an example in which the masked data “ . . . tomorrow's calendar” created from the restored data of the operator W1 is relayed to the operator W2 and the operator W3, the transfer of the masked data between the operators is not limited to one time. For example, it is also possible to further create masked data “show me tomorrow's . . . ” from restored data “show me tomorrow's calendar” of the operator W2 and then relay the masked data to other operators, for example, operators other than the operators W1 to W3, or the operator W1 or the operator W3. It is also possible to further create masked data “display tomorrow's . . . ” from the restored data “display tomorrow's calendar” of the operator W3 and then relay the masked data to other operators, for example, operators other than the operators W1 to W3, or the operator W1 or the operator W2.

Although FIG. 6 illustrates an example in which only the operator is included, the above-described virtual worker may be included in a part of the relay. At this time, when the utterance case deviates from the domain of the semantic symbol in the middle of the relay, this case is treated as a negative instance and will be discarded. In particular, in the case of a virtual worker, since it is conceivable to provide many negative instances, it is allowable to preliminarily output some candidates.

<7-3. Providing Context>

Although the above-described embodiment is an example in which masked data is presented to the operator terminal 30 at the time of creating an utterance case, it is also possible to present information other than this to the operator terminal 30. For example, coming up with an utterance directly from a semantic symbol requires powerful imagination, and thus, it is possible to stimulate the operators to expand imagination by giving them various contexts.

Merely as an example, when there is a document defining a use case or the like in the semantic symbol in system development, it is possible to utilize the document. For example, as one use case of a semantic symbol “SCHEDULE-CHECK”, when there is a definition “running with a necklace-type wearable agent. During running, having a desire to check whether the schedule of the restaurant with wife on the weekend is on Saturday or Sunday”, it is possible to display texts and illustrations of the use case. In addition, as a use case of a semantic symbol “FACILITY-CHECK”, when there is a definition “discussing, with wife, possible places for hanging around with family members (wife and child) on the weekend. Because of busy situation past week, nearby and inexpensive places would be desirable”, it is possible to display texts and illustrations of the use case.

In addition, the context can be created using an interaction log recorded in the interactive system or the interactive agent. For example, when there is an utterance case belonging to a semantic symbol, for example, an utterance asking weather to the interactive system or the interactive agent, the interactive log from which the utterance has been deleted can be displayed as a context. With this configuration, it is also possible, for example, to present utterances before and after the utterance asking the weather to the interactive system or the interactive agent so as to expand imagination regarding the deleted utterance.

<7-4. Support for Efficient Data Collection for Training Model>

For one semantic symbol, for example, weather confirmation, it is conceivable that an end user of an interactive agent uses the system with utterances with wide variations. To achieve this, it is desirable to be able to collect as various utterances as possible in advance. In view of this, the development support device 10 of the present disclosure can collect high-quality data by implementing an evaluation method of a set of registered utterance cases, for example, an utterance case of corpus data or an utterance case of corpus data and restored data and performing feedback of an evaluation result to the operator.

<7-4-1. Visualization of Utterance Cases>

It is conceivable to define a plurality of semantic symbols in one interactive agent. Generally, by defining many semantic symbols, there is an increasing possibility of occurrence of domain collisions between the semantic symbols, making it difficult to perform classification of the semantic symbols. In a case, however, where a large number of utterance cases are registered in the corpus data 13C, it would be difficult to confirm collision avoidance of domains because of scarcity of visual information in language. In view of this, the present embodiment proposes a design of a semantic space based on visualization of domains of semantic symbols as described below.

Here, in the aspect of implementing visualization, an utterance case is encoded by a predetermined technique to be converted into a numerical expression such as a vector expression, and visualization of the numerical expression is performed.

Examples of the above-described encoding method include Bag-of-Words using a word or a character in a sentence of an utterance case. In this method, using a vector of a one-dimensional array having the number of occurring vocabularies of the entire utterance cases registered in the corpus data 13C, the value of the element corresponding to the vocabulary occurring in the utterance case is set to 1, and the value of the element corresponding to the vocabulary not occurring in the utterance case is set to 0. Other examples of applicable encoding methods include a simple word-embedding-based method (SWEM), which is a method of calculating sentence embedding in an utterance case using word embedding included in the utterance case. This makes it possible to map a word or a sentence to a fixed-length vector using a neural network. Since this neural network is pre-trained based on a large-scale corpus and the like, it is possible to capture features such as words that are likely to co-occur. As a further encoding method, it is possible to use an output obtained from a specific layer of a trained neural network after inputting an utterance case to an input layer of the neural network. A neural network includes layers which are composed of neurons and being stacked in multiple stages, and it is possible to utilize a specific layer, for example, one layer before the final layer, of the neural network. This makes it possible to acquire an expression suitable for the task.

<7-4-2. One Aspect of Visualization Effect>

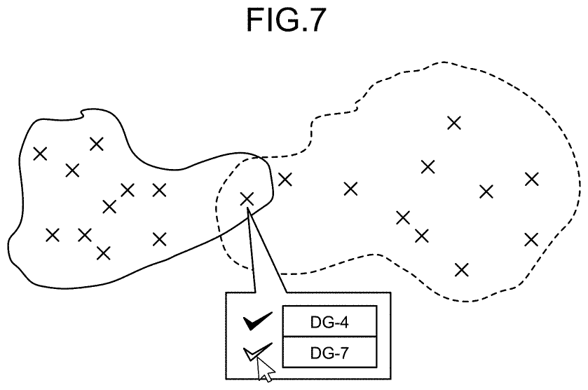

Furthermore, there is a visualization method capable of compressing numerical expression of the utterance case to a predetermined dimension, for example, two dimensions, by using dimension compression such as t-SNE. This makes it possible to generate a map in which each of the utterance cases included in the corpus data 13C is plotted on a two-dimensional space. FIG. 7 is a diagram illustrating an example of the visualization map. FIG. 7 is a diagram, in which, as an example, utterance cases included in the corpus data 13C are plotted with cross marks on a two-dimensional visualization map. Furthermore, in FIG. 7, a convex hull including an utterance case having a semantic symbol label “DG-4” is displayed by a solid line, and a convex hull including an utterance case having a semantic symbol label “DG-7” is displayed by a broken line. The visualization map illustrated in FIG. 7 includes utterance cases registered with multi-label registration using the semantic symbol label “DG-4” and the semantic symbol label “DG-7”. When such a visualization map is displayed on the operation requester terminal 50 or the like, it is possible to receive the selection of a label of an utterance case corresponding to a multi-label from the operation requester terminal 50 or the like as illustrated in FIG. 7. However, there is also a case where it is correct to include the utterance case in the domains of both semantic symbols. Therefore, it is not always necessary to narrow down the cases to alternative labels, and it is allowable to maintain multi-labels.

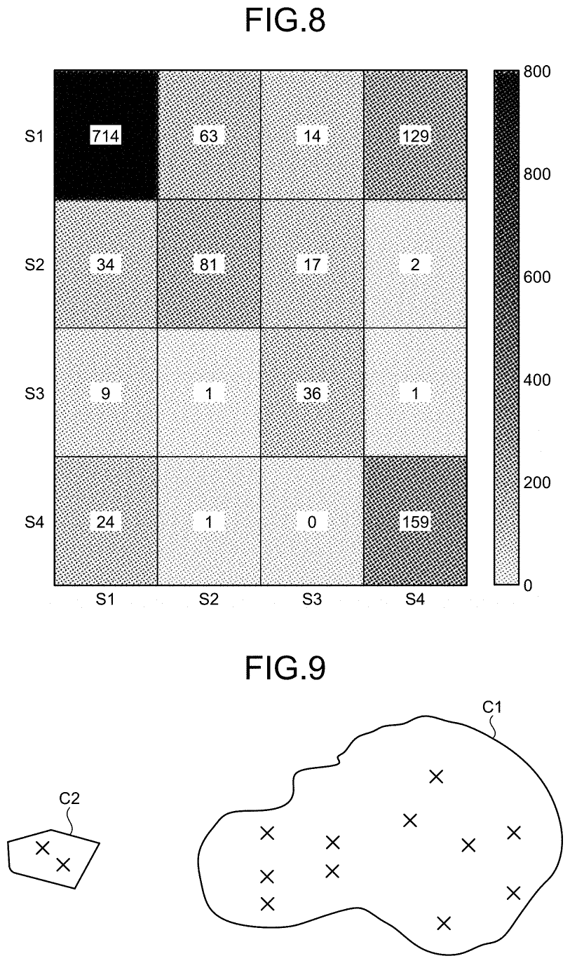

Furthermore, the development support device 10 of the present disclosure can display, for each utterance case included in the corpus data 13C, a comparison result between a ground truth label of a semantic symbol allocated to the utterance case and a predicted label of a semantic symbol predicted by inputting the utterance case to the module of utterance semantic analysis. Merely as an example, the comparison result between the ground truth label and the predicted label can be displayed as a confusion matrix. FIG. 8 is a diagram illustrating an example of the confusion matrix. FIG. 8 illustrates an example in which four semantic symbols S1 to S4 are defined in a module of utterance semantic analysis. Furthermore, in FIG. 8, the ground truth labels of the semantic symbol are arranged along the vertical axis of the confusion matrix while the predicted labels of the semantic symbol predicted in the module of utterance semantic analysis are arranged along the horizontal axis. Furthermore, as illustrated in a legend illustrated in FIG. 8, a total value of the utterance cases belonging to an element of the confusion matrix is displayed in the element, in a manner such that the more the number of utterance cases, the thicker the utterance cases are displayed. In the confusion matrix illustrated in FIG. 8, an utterance case in which the ground truth label of a semantic symbol and the predicted label of the semantic symbol match is totaled to a value of any of elements on a diagonal line extending downward to the right, namely, elements in the first row and the first column, the second row and the second column, the third row and third column, and the fourth row and the fourth column of the confusion matrix. With this matrix, it is possible to grasp that the prediction accuracy of the module of utterance semantic analysis is deteriorated in the non-truth elements other than the first row and the first column, the second row and the second column, the third row and the third column, and the fourth row and the fourth column, that is, the elements having the total value being equal to or more than a predetermined threshold among the elements in which the ground truth label and the predicted label do not match, for example, the elements in the first row and the fourth column displayed with thick hatching. In this scenario, it can be seen that, although the ground truth label of the semantic symbol is S1, the label of the utterance case has been erroneously predicted as S4 in many situations. As a result, an utterance case located within a predetermined distance from a boundary between the domain of the semantic symbol “S1” and the domain of the semantic symbol “S4” can be manually or automatically set as an extraction target by the acquisition unit 15A.

These visualizations can achieve the following effects. For example, it is possible to confirm whether the domain of the semantic symbol is appropriate. As a specific example, when the domain of the semantic symbol is extremely large or small, it is possible to notice the possibility of redefining the semantic symbol. Furthermore, it is possible to detect an utterance case having a collision of domains of the semantic symbols, or being in the vicinity of the boundary of the domains of the semantic symbols, for example, an utterance case whose distance from the boundary is within a threshold. For the utterance cases detected in this manner, the corresponding utterance can be directly labeled again. There is also the possibility of being multi-labeled and suitable in either semantic space. Furthermore, by setting the utterance cases near the boundary as a target of extraction by the acquisition unit 15A, the boundary of the domain of the semantic symbol can be further clarified. That is, regarding the semantic symbol whose boundary of domains overlaps or approaches, by setting the utterance cases in the vicinity of the boundary of each domain as a target of extraction by the acquisition unit 15A, it is possible to increase the number of samples for defining a separation surface of the boundary. As a result, the model used by the module of utterance semantic analysis is retrained. By re-visualizing the prediction result by the module of utterance semantic analysis in which the model has been retrained in this manner, it is possible to reduce duplication of utterance cases and increase the possibility of having a distance with a sufficient margin. Furthermore, an utterance case that does not belong to any semantic symbol and is located within a predetermined distance from the boundary of the domains of a plurality of semantic symbols can be purposely registered as an utterance case as a negative instance. For example, by adding a case that is notationally similar but completely different semantically, the model can be trained to preclude the negative instance from prediction. Furthermore, an utterance case corresponding to restored data generated from the text restored by the operator terminal 30 can be mapped on the domain of the semantic symbol for each operator terminal 30. This will facilitate understanding what type of utterance data is insufficient. For example, when there are four utterance cases belonging to a domain of an identical semantic symbol, such as “tomorrow's weather”, “weather in the afternoon”, “tell me tomorrow's weather”, and “need an umbrella tomorrow?”, three sentences “tomorrow's weather”, “weather in the afternoon”, and “tell me tomorrow's weather” are expected to be mapped close to each other, whereas “need an umbrella tomorrow?” is expected to be mapped to a position at a slight distance from the three sentences. In this situation, regarding an utterance case to be added next, it is possible to produce a motivation to add an utterance case similar to an utterance case “need an umbrella tomorrow?” located in a low density region in the aspect of equalizing the density of utterance cases.

<7-5. Linkage with Evaluation>

When an utterance case is newly additionally registered in the corpus data 13C, it is possible to perform classification evaluation by comparing a ground truth label of a semantic symbol with a predicted label of a semantic symbol by a module of utterance semantic analysis for each of the utterance cases included in the corpus data 13C at an arbitrary timing. At this time, in the middle of creating the corpus data 13C, excess or shortage of the registration data can be confirmed by the automatic evaluation result. For example, by generating a confusion matrix, semantic symbols with low classification performance can be detected. Furthermore, visualizing the domain of the semantic symbol makes it possible to detect an utterance case within a predetermined distance from the boundary, set the detected utterance case as a target to be extracted by the acquisition unit 15A, perform re-labeling, redesign the domain of the semantic symbol, and the like.

<7-6. Support for Collection of Utterance Cases Connecting Isolated Regions>

An utterance case included in the corpus data 13C is encoded and visualized. Next, execution of clustering such as k-means makes it possible to visualize cluster regions. FIG. 9 is a diagram illustrating an example of a cluster. In FIG. 9, a result of clustering of utterance cases having the same ground truth labels of the semantic symbols is visualized on a map. As illustrated in FIG. 9, when utterance cases having the same ground truth label of the semantic symbol are divided into a cluster C1 and a cluster C2 as isolated regions being isolated from each other, this will be a factor of lowering a performance of the identification model. Therefore, the following processing can be performed in an aspect of filling the gap of the isolated regions.

For example, the development support device 10 of the present disclosure can automatically set a pair of utterance cases having the shortest distance between the clusters as isolated region as a target of extraction by the acquisition unit 15A. In addition, it is also possible to highlight a pair of utterance cases on the operation requester terminal 50 or the like and manually receive an operation of setting the pair as a target of extraction by the acquisition unit 15A. Furthermore, the development support device 10 according to the present disclosure generates a predetermined number of utterance cases by using a pre-trained language model and pre-registered corpus data 13C. It is also possible to extract an utterance case within a predetermined distance from the boundary for each cluster being mutually isolated regions from the utterance texts generated in this manner and display the extracted utterance case on the operator terminal 30 or the operation requester terminal 50. This makes it possible to create an utterance case with reference to the extracted utterance case. Furthermore, it is possible to set the extracted utterance case as the target of extraction by the acquisition unit 15A, or possible to receive from the operation requester terminal 50 the setting of the ground truth label being either a positive instance or a negative instance for the utterance case.

<<8. Modifications>>

The above-described embodiment is an example, and various modifications are possible.

<8-1. Modification of Cases>

Although the utterance cases have been described as an example of a case, the development support device 10 of the present disclosure can similarly apply the processing illustrated in FIGS. 3 to 5 to a case of augmenting variations of cases other than the utterance cases.

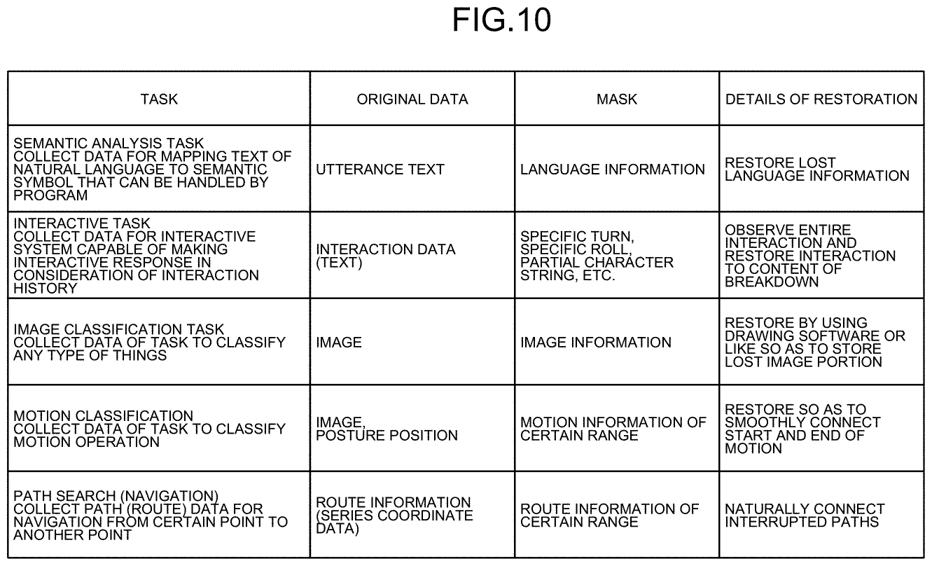

FIG. 10 is a diagram illustrating a modification of cases. FIG. 10 illustrates a list of tasks, original data, masks, and details of restoration. As illustrated in FIG. 10, when a task is utterance semantic analysis, an utterance text is used as original data corresponding to the case. In this situation, after generation of masked data in which language information of the utterance text in the original data is masked, the language information is restored via the operator terminal 30. Furthermore, when the task is interaction, the interaction text is used as the original data corresponding to the case. In this situation, after generation of masked data having a mask on an utterance text of a specific turn, an utterance text of a specific role, or a partial character string thereof, among the utterance texts included in the interaction text of the original data, the utterance of the specific turn or the specific role is restored from the context of the entire interaction via the operator terminal 30. In addition, when the task is an image classification, images are used as original data corresponding to the case. In this situation, after generation of the masked data in which a part of the image of the original data is masked, drawing information, for example, line drawing information for interpolating the masked portion, is restored through the drawing software or the like executed by the operator terminal 30. Furthermore, when the task is motion classification, images or posture positions of a predetermined number of frames included in the motion are used as the original data corresponding to the case. In this situation, after generation of masked data in which a part of the frame included in the motion of the original data is masked, restoration of interpolating the image and the posture motion of the frame corresponding to the masked portion is performed via the operator terminal 30. In addition, when the task is a path search, route information including series coordinate data such as sensor data is used as original data corresponding to the case. In this situation, after generation of masked data in which a part of the route information of the original data is masked, the partial route corresponding to the masked portion is restored via the operator terminal 30.

<8-1-1. Interactive Task>

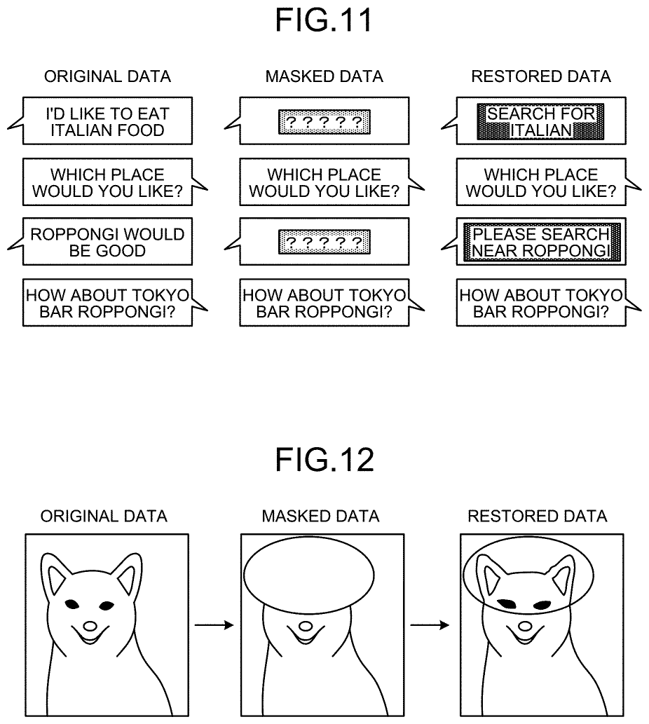

FIG. 11 is a diagram illustrating an example of a method of augmentation of a case in an interactive task. FIG. 11 illustrates original data, masked data, and restored data at the time of augmenting variations of a case in an interactive task. In the example illustrated in FIG. 11, masked data is generated by masking an utterance text of a specific turn, for example, the first turn and the third turn, out of the interaction text in the original data. Furthermore, restored data is generated by receiving restoration of the first turn and the third turn. Variations of the interaction text belonging to the common semantic symbol can be augmented by an error occurring through the information loss and information restoration. Although described herein is an example of masking the utterance text of the specific turn, it is also allowable to mask a part of an utterance text of a specific turn, for example, a character, a character string, a word, or a phrase, or even possible to mask only a certain role of a person or a system.

<8-1-2. Image Classification Task>

FIG. 12 is a diagram illustrating an example of a method of augmentation of a case in an image classification task. FIG. 12 illustrates original data, masked data, and restored data at the time of augmenting variations of a case in an image classification task. In the example illustrated in FIG. 12, masked data is generated by masking a predetermined region of a dog image in the original data, for example, a partial region including eyes and ears identified from facial features. Furthermore, restored data is generated by receiving restoration of the eyes and ears of the dog. By using these information loss and information restoration errors, variations of images belonging to a common class “dog” can be augmented. Note that the masked portion is not limited to the partial region illustrated in FIG. 12. For example, a peripheral portion of a part of the contour obtained by the edge detection may be masked. Furthermore, it is allowable to configure to restore not only line drawing information but also color information. Furthermore, the image classification can include character recognition such as numerical values, symbols, and characters in the category.

<8-1-3. Motion Classification Task>

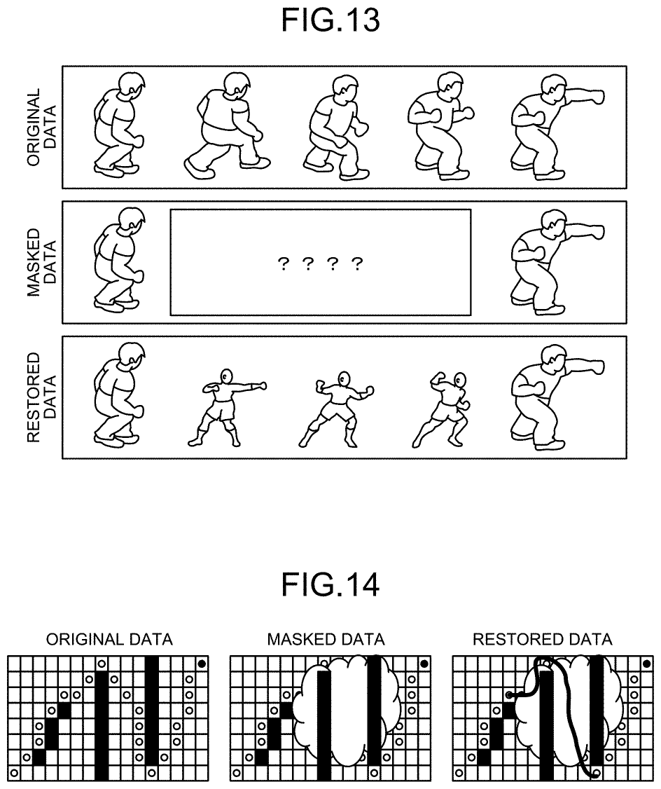

FIG. 13 is a diagram illustrating an example of a method of augmentation of a case in a motion classification task. FIG. 13 illustrates original data, masked data, and restored data at the time of augmenting variations of a case in a motion classification task. In the example illustrated in FIG. 13, after generation of the masked data in which images of the second to fourth frames included in a punch motion in the original data are masked, restoration of interpolating the images of the second to fourth frames is performed via the operator terminal 30. By using these information loss and information restoration errors, variations of images of motion belonging to a common class “punch” can be augmented. Although punch is used as an example of the motion, the motion may include any motion such as jumping, running, elevating, kicking, dashing, browsing a wristwatch, or taking out a smartphone.

<8-1-4. Path Search Task>

FIG. 14 is a diagram illustrating an example of a method of augmentation of a case in a path search task. FIG. 14 illustrates original data, masked data, and restored data at the time of augmenting variation of a case in a path search task. In an example illustrated in FIG. 14, masked data is generated by masking a part of the route information in original data. Furthermore, restored data is generated by receiving restoration of a partial route corresponding to the masked portion via the operator terminal 30. By using these information loss and information restoration errors, variations of common route information can be augmented.

<8-2. Other Modifications>

Furthermore, among individual processing described in the above embodiments, all or a part of the processing described as being performed automatically may be manually performed, or the processing described as being performed manually can be performed automatically by known methods. In addition, the processing procedures, specific names, and information including various data and parameters illustrated in the above Literatures or drawings can be arbitrarily altered unless otherwise specified. For example, various types of information illustrated in each of the drawings are not limited to the information illustrated.

In addition, each of the components of each of the illustrated devices is provided as a functional and conceptional illustration and thus does not necessarily have to be physically configured as illustrated. That is, the specific form of distribution/integration of each of the devices is not limited to those illustrated in the drawings, and all or a part thereof may be functionally or physically distributed or integrated into arbitrary units according to various loads and use conditions.

The effects described in individual embodiments of the present specification are merely examples, and thus, there may be other effects, not limited to the exemplified effects.

<9. Hardware Configuration>

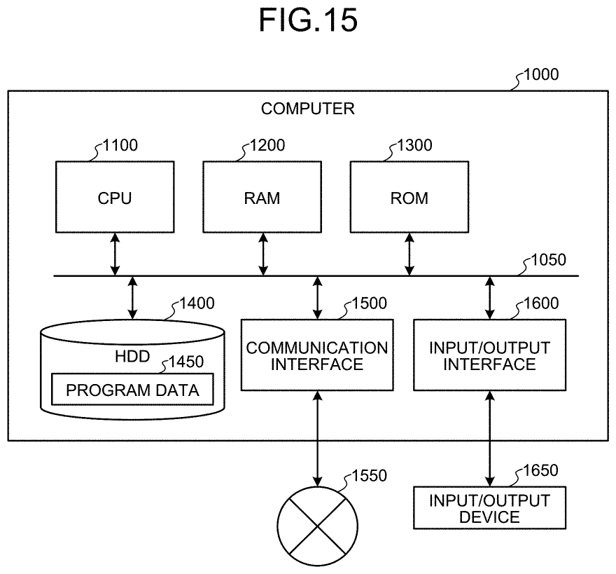

The development support device 10 according to each embodiment described above is implemented by a computer 1000 having a configuration as illustrated in FIG. 15, for example. Hereinafter, description will be given using the development support device 100 according to the above-described embodiments as an example. FIG. 15 is a hardware configuration diagram illustrating an example of the computer 1000 that implements functions of the development support device 100. The computer 1000 includes a CPU 1100, RAM 1200, read only memory (ROM) 1300, a hard disk drive (HDD) 1400, a communication interface 1500, and an input/output interface 1600. Individual components of the computer 1000 are interconnected by a bus 1050.

The CPU 1100 operates based on a program stored in the ROM 1300 or the HDD 1400 so as to control each of components. For example, the CPU 1100 develops the program stored in the ROM 1300 or the HDD 1400 into the RAM 1200 and executes processing corresponding to various programs.

The ROM 1300 stores a boot program such as a basic input output system (BIOS) executed by the CPU 1100 when the computer 1000 starts up, a program dependent on hardware of the computer 1000, or the like.

The HDD 1400 is a non-transitory computer-readable recording medium that records a program executed by the CPU 1100, data used by the program, or the like. Specifically, the HDD 1400 is a recording medium that records a development support program according to the present disclosure, which is an example of program data 1450.

The communication interface 1500 is an interface for connecting the computer 1000 to an external network 1550 (for example, the Internet). For example, the CPU 1100 receives data from other devices or transmits data generated by the CPU 1100 to other devices via the communication interface 1500.

The input/output interface 1600 is an interface for connecting between an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface for reading a program or the like recorded on predetermined recording medium (or simply medium). Examples of the media include optical recording media such as a digital versatile disc (DVD) or a phase change rewritable disk (PD), a magneto-optical recording medium such as a magneto-optical disk (MO), a tape medium, a magnetic recording medium, and semiconductor memory.

For example, when the computer 1000 functions as the development support device 100 according to the above-described embodiment, the CPU 1100 of the computer 1000 executes the development support program loaded on the RAM 1200 to implement the functions of the control unit 15. Furthermore, the HDD 1400 stores the development support program according to the present disclosure or data in a content storage unit 121. While the CPU 1100 executes program data 1450 read from the HDD 1400, the CPU 1100 may acquire these programs from another device via the external network 1550, as another example.

Note that the present technology can also have the following configurations.

(1)

An information processing apparatus including:

an acquisition unit that acquires original data;

a masking unit that performs mask processing on a part of the original data; and

a restoration reception unit that receives an input of restoring a masked portion of masked data obtained by the mask processing.

(2)

The information processing apparatus according to (1),

wherein the acquisition unit acquires an utterance text as the original data, and

the masking unit performs mask processing on a part of the utterance text in the original data.

(3)

The information processing apparatus according to (2),

wherein the masking unit performs mask processing on a predetermined word class or a predetermined portion indicating a syntactic dependency relationship in the utterance text in the original data.

(4)

The information processing apparatus according to (2),

wherein the masking unit performs mask processing on a predetermined number of content words in the utterance text in the original data.

(5)

The information processing apparatus according to (2),

wherein the masking unit performs mask processing on a predetermined number of characters in the utterance text in the original data.

(6)

The information processing apparatus according to (2),

wherein the masking unit performs mask processing on a prefix or a suffix in the utterance text in the original data.

(7)

The information processing apparatus according to (2),

wherein, when a text restored based on the input satisfies a predetermined constraining condition, the restoration reception unit permits registration of an utterance case based on the input, to a corpus.

(8)

The information processing apparatus according to (7),

wherein, when a number of characters of the text restored based on the input is different from a number of characters of a text of the masked portion, the restoration reception unit permits registration of the utterance case based on the input, to the corpus.

(9)

The information processing apparatus according to (7),

wherein, when a predetermined prohibited character is not included in the text restored based on the input, the restoration reception unit permits registration of the utterance case based on the input, to the corpus.

(10)

The information processing apparatus according to (7),

wherein, when an edit distance between the text restored based on the input and the text of the masked portion is equal to or more than a threshold, the restoration reception unit permits registration of the utterance case based on the input, to the corpus.

(11)

The information processing apparatus according to (7),

wherein, when language form, being one of a colloquial language or a written language, of the text restored based on the input is different from language form of the text of the masked portion, the restoration reception unit permits registration of the utterance case based on the input, to the corpus.

(12)

The information processing apparatus according to (7), further including:

a conversion unit that converts the utterance case registered in the corpus into a numerical expression; and

a visualization unit that visualizes the utterance case by plotting the utterance case on a map having a predetermined number of dimensions based on the numerical expression obtained by conversion performed by the conversion unit.

(13)

The information processing apparatus according to (12),

wherein, by displaying a convex hull of utterance cases having a common ground truth label of a semantic symbol assigned to the utterance cases based on the ground truth label, the visualization unit visualizes a domain of the semantic symbol.

(14)

The information processing apparatus according to (13),

wherein the visualization unit further visualizes an utterance case located within a predetermined distance from a boundary of the domain of the semantic symbol.

(15)

The information processing apparatus according to (13),

wherein the acquisition unit acquires an utterance case located within a predetermined distance from a boundary of the domain of the semantic symbol, as the original data.

(16)

The information processing apparatus according to (7),

further including a visualization unit that visualizes a comparison result between a predicted label of a semantic symbol predicted by inputting an utterance case registered in the corpus to a module of utterance semantic analysis and a ground truth label of a semantic symbol to which the utterance case belongs.

(17)

The information processing apparatus according to (16),

wherein the comparison result is displayed as a confusion matrix.

(18)

The information processing apparatus according to (17),

wherein the acquisition unit acquires, as the original data, an utterance case corresponding to a combination in which the predicted label and the ground truth label do not match, and a total value of utterance cases is equal to or more than a predetermined threshold, among combinations of the predicted label and the ground truth label included in the confusion matrix.

(19)

An information processing method executed by a computer, the method including processing of:

acquiring original data;

performing mask processing on a part of the original data; and

receiving an input of restoring a masked portion of masked data obtained by the mask processing.

(20)

An information processing program causing a computer to execute processing of:

acquiring original data;

performing mask processing on a part of the original data; and

receiving an input of restoring a masked portion of masked data obtained by the mask processing.

### REFERENCE SIGNS LIST

1 SYSTEM
10 DEVELOPMENT SUPPORT DEVICE
11 COMMUNICATION INTERFACE
13 STORAGE UNIT
13A TASK DATA
13A1 ORIGINAL DATA
13B RESTORED DATA
13C CORPUS DATA
15 CONTROL UNIT
15A ACQUISITION UNIT
15B MASKING UNIT
15C ALLOCATION UNIT
15D RESTORATION RECEPTION UNIT
15E PROGRESS MANAGEMENT UNIT
15F REGISTRATION UNIT
30A, 30B, 30N OPERATOR TERMINAL
50 OPERATION REQUESTER TERMINAL

1. An information processing apparatus including:
an acquisition unit that acquires original data;
a masking unit that performs mask processing on a part of the original data; and
a restoration reception unit that receives an input of restoring a masked portion of masked data obtained by the mask processing.

2. The information processing apparatus according to claim 1,
wherein the acquisition unit acquires an utterance text as the original data, and
the masking unit performs mask processing on a part of the utterance text in the original data.

3. The information processing apparatus according to claim 2,
wherein the masking unit performs mask processing on a predetermined word class or a predetermined portion indicating a syntactic dependency relationship in the utterance text in the original data.

4. The information processing apparatus according to claim 2,
wherein the masking unit performs mask processing on a predetermined number of content words in the utterance text in the original data.

5. The information processing apparatus according to claim 2,
wherein the masking unit performs mask processing on a predetermined number of characters in the utterance text in the original data.

6. The information processing apparatus according to claim 2,
wherein the masking unit performs mask processing on a prefix or a suffix in the utterance text in the original data.

7. The information processing apparatus according to claim 2,
wherein, when a text restored based on the input satisfies a predetermined constraining condition, the restoration reception unit permits registration of an utterance case based on the input, to a corpus.

8. The information processing apparatus according to claim 7,
wherein, when a number of characters of the text restored based on the input is different from a number of characters of a text of the masked portion, the restoration reception unit permits registration of the utterance case based on the input, to the corpus.

9. The information processing apparatus according to claim 7,
wherein, when a predetermined prohibited character is not included in the text restored based on the input, the restoration reception unit permits registration of the utterance case based on the input, to the corpus.

10. The information processing apparatus according to claim 7,
wherein, when an edit distance between the text restored based on the input and the text of the masked portion is equal to or more than a threshold, the restoration reception unit permits registration of the utterance case based on the input, to the corpus.

11. The information processing apparatus according to claim 7,
wherein, when language form, being one of a colloquial language or a written language, of the text restored based on the input is different from language form of the text of the masked portion, the restoration reception unit permits registration of the utterance case based on the input, to the corpus.

12. The information processing apparatus according to claim 7, further including:
a conversion unit that converts the utterance case registered in the corpus into a numerical expression; and
a visualization unit that visualizes the utterance case by plotting the utterance case on a map having a predetermined number of dimensions based on the numerical expression obtained by conversion performed by the conversion unit.

13. The information processing apparatus according to claim 12,
wherein, by displaying a convex hull of utterance cases having a common ground truth label of a semantic symbol assigned to the utterance cases based on the ground truth label, the visualization unit visualizes a domain of the semantic symbol.

14. The information processing apparatus according to claim 13,
wherein the visualization unit further visualizes an utterance case located within a predetermined distance from a boundary of the domain of the semantic symbol.

15. The information processing apparatus according to claim 13,
wherein the acquisition unit acquires an utterance case located within a predetermined distance from a boundary of the domain of the semantic symbol, as the original data.

16. The information processing apparatus according to claim 7,
further including a visualization unit that visualizes a comparison result between a predicted label of a semantic symbol predicted by inputting an utterance case registered in the corpus to a module of utterance semantic analysis and a ground truth label of a semantic symbol to which the utterance case belongs.

17. The information processing apparatus according to claim 16,
wherein the comparison result is displayed as a confusion matrix.

18. The information processing apparatus according to claim 17,
wherein the acquisition unit acquires, as the original data, an utterance case corresponding to a combination in which the predicted label and the ground truth label do not match, and a total value of utterance cases is equal to or more than a predetermined threshold, among combinations of the predicted label and the ground truth label included in the confusion matrix.

19. An information processing method executed by a computer, the method including processing of:
acquiring original data;
performing mask processing on a part of the original data; and
receiving an input of restoring a masked portion of masked data obtained by the mask processing.

20. An information processing program causing a computer to execute processing of:
acquiring original data;
performing mask processing on a part of the original data; and
receiving an input of restoring a masked portion of masked data obtained by the mask processing.
